(19) United States
(12) Patent Application Publication
(10) Pub. No.: US 2009/0102917 A1
(43) Pub. Date: Apr. 23, 2009

(54) BIDIRECTIONAL COMMUNICATION DEVICE

(75) Inventor: Tadashi MINAKUCHI, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/246,610

(22) Filed: Oct. 7, 2008

(30) Foreign Application Priority Data
Oct. 10, 2007 (JP) 2007-264657

(51) Int. Cl. H04N 7/18; H04N 7/00

(52) U.S. Cl. 348/65; 375/354; 348/E07.085

(57) ABSTRACT

A bidirectional communication device for an electronic endoscope provided with a videoscope having an imaging function and generating a scope information signal, has a communication channel, a first communication circuit and a second communication circuit. The first communication circuit outputs a clock signal to the communication channel in order to perform the imaging function in the videoscope. The second communication circuit receives the clock signal through the communication channel and amplifies the clock signal to generate an amplified clock signal. The second communication circuit superimposes the scope information signal onto the amplified clock signal to generate a superimposed signal, which is transmitted to the first communication circuit through the communication channel. The first communication circuit obtains the scope information signal from the superimposed signal at a timing corresponding to the clock signal.

### BACKGROUND OF THE INVENTION

1. Field of the Invention

The present invention relates to a bidirectional communication device which is provided in a system such as an electronic endoscope to communicate various signals or data through a communication channel.

2. Description of the Related Art

Conventionally, an electronic endoscope is provided with a videoscope having an imaging device (e.g. a CCD) and a video processor which generates control signals for the imaging device and processes an image signal generated by the imaging device.

Japanese Unexamined Patent Publication (KOKAI) No. 2004-321491 discloses an electronic endoscope in which the control signals are generated in a control circuit mounted in a video processor, and are transmitted to the imaging device, which is disposed at the distal end of a videoscope, through a communication channel (e.g. a wire). At the same time, the image signal is transmitted to a signal-processing circuit disposed in the video processor through another communication channel. Additionally, in the electronic endoscope disclosed in Japanese Unexamined Patent Publication (KOKAI) No. 2004-32149, a subject's body temperature can be measured with a thermal sensor disposed at the distal end of the videoscope.

Furthermore, Japanese Unexamined Patent Publication (KOKAI) No. 2006-6569 discloses an electronic endoscope having an electronic circuit including an imaging device, in which the electronic circuit is driven by a battery which is disposed at the distal end of the videoscope and is rechargeable by an electromagnetic induction method.

In that electronic endoscope, in which the videoscope has a battery or special functions (e.g. temperature measurement), it is desirable that information such as the operating status or output data of those functions be transmitted from the videoscope to the video processor so as to be monitored by the user or operator.

However, providing an exclusive communication channel in order to transmit the information from the videoscope to the video processor requires increasing the outer diameter of the insertion tube of the videoscope, which would cause greater discomfort or inflict pain on the subject or patient.

### SUMMARY OF THE INVENTION

Therefore, an object of the present invention is to provide a bidirectional communication device for an electronic endoscope, which can transmit the information from the videoscope to the video processor without increasing the outer diameter of the insertion tube of the videoscope.

A first aspect of the present invention is a bidirectional communication device for an electronic endoscope provided with a videoscope having an imaging function and generating a scope information signal, the device comprising a communication channel, a first communication circuit, and a second communication circuit. The first communication circuit outputs a clock signal through the communication channel in order to perform the imaging function in the videoscope. The second communication circuit receives the clock signal through the communication channel and amplifies the clock signal and thereby generates an amplified clock signal. The second communication circuit superimposes the scope information signal onto the amplified clock signal to generate a superimposed signal, which is transmitted to the first communication circuit through the communication channel. The first communication circuit obtains the scope information signal from the superimposed signal at a timing corresponding to the clock signal.

A second aspect of the present invention is an electronic endoscope having a videoscope, a secondary battery, a communication channel, a first communication circuit, and a second communication circuit. The videoscope has an imaging device and generates a scope information signal. The secondary battery drives the imaging device, and the scope information signal indicates the remaining charge in the secondary battery. The first communication circuit outputs a clock signal to the communication channel in order to perform the imaging function in the videoscope. The second communication circuit receives the clock signal through the communication channel and amplifies the clock signal to generate an amplified clock signal, and the second communication circuit superimposes the scope information signal onto the amplified clock signal to generate a superimposed signal which is transmitted to the first communication circuit through the communication channel. The first communication circuit obtains the scope information signal from said superimposed signal at a timing corresponding to the clock signal.

A third aspect of the present invention is an electronic endoscope having a videoscope, a thermal sensor, a communication channel, a first communication circuit, and a second communication circuit. The videoscope has an imaging device and generates a scope information signal. The thermal sensor senses the temperature around the distal end of the videoscope, producing a scope information signal corresponding to the output of the thermal sensor. The first communication circuit outputs a clock signal through the communication channel in order to perform the imaging function. The second communication circuit receives the clock signal through the communication channel and amplifies the clock signal to generate an amplified clock signal. The second communication circuit superimposes the scope information signal onto the amplified clock signal to generate a superimposed signal, which is transmitted to the first communication circuit through the communication channel. The first communication circuit obtains the scope information signal from the superimposed signal at a timing corresponding to the clock signal.

A fourth aspect of the present invention is a bidirectional communication device having a communication channel, a first communication circuit, and a second communication circuit. The first communication circuit outputs a clock signal through the communication channel. The second communication circuit receives the clock signal through the communication channel and amplifies the clock signal to generate an amplified clock signal. The second communication circuit superimposes an input signal, which is input from outside the second communication circuit, onto the amplified clock signal to generate a superimposed signal which is transmitted to the first communication circuit through the communication channel. The first communication circuit obtains the input signal from the superimposed signal at a timing corresponding to the clock signal.

### BRIEF DESCRIPTION OF THE DRAWINGS

The objects and advantages of the present invention will be better understood from the following description, with reference to the accompanying drawings in which:

FIG. 1 is a block diagram of an electronic endoscope to which a first embodiment of the present invention is applied;

FIG. 2 is a block diagram showing a first communication circuit and a second communication circuit to which the first embodiment of the present invention is applied;

FIG. 3 is a timing diagram showing the operation of the first communication circuit and the second communication circuit to which the first embodiment of the present invention is applied;

FIG. 4 is a timing diagram showing the operation of the first communication circuit and the second communication circuit to which a second embodiment of the present invention is applied;

FIG. 5 is a block diagram showing a first communication circuit and a second communication circuit to which a third embodiment of the present invention is applied;

FIG. 6 is a timing diagram showing the operation of the first communication circuit and the second communication circuit to which the third embodiment of the present invention is applied; and

FIG. 7 is a timing diagram showing the operation of the first communication circuit and the second communication circuit to which a fourth embodiment of the present invention is applied.

### DESCRIPTION OF THE PREFERRED EMBODIMENTS

The present invention will be described below with reference to the embodiments shown in the drawings.

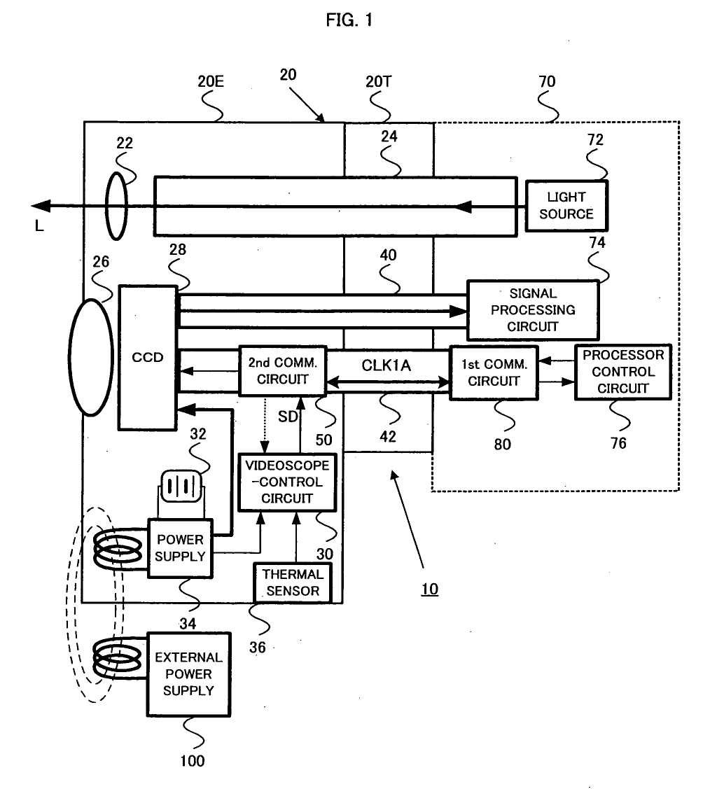

FIG. 1 shows an electronic endoscope including a bidirectional communication device to which a first embodiment of the present invention is applied. The endoscope system has a videoscope 20 and a video processor 70. The videoscope 20 includes an insertion part (not shown), inserted into the body of the subject or patient, and a universal cord 20T. A videoscope end 20E, which is the distal end of the insertion part, and the video processor 70 are connected electrically and optically with the universal cord 20T.

The video processor 70 has a light source 72 which outputs illumination light L. The illumination light L is transmitted to the videoscope end 20E via a guide fiber 24 disposed in the videoscope 20, and it is then diffused by a diffusion lens 22. The subject (not shown) is illuminated by the illumination light L, and the illumination light L reflected by the subject strikes the videoscope end 20E.

The videoscope end 20E has an objective lens 26, a CCD (imaging device) 28, a videoscope-control circuit 30, a secondary battery 32, a power supply 34, a thermal sensor 36, and a second communication circuit 50. An image is formed on the CCD 28 by the illumination light L reflected by the subject.

The CCD 28 is driven with a clock signal generated by a processor control circuit 76 disposed in the video processor 70. The clock signal is output from a first communication circuit 80 disposed in the video processor 70, and supplied to the CCD 28 through a communication channel 42 and the second communication circuit 50. A horizontal CCD driving signal (φH), a reset pulse signal (φR), or a vertical CCD driving signal (φV) may instantiate the clock signal. Note that, although each of the horizontal CCD driving signal (φH), the reset pulse signal (φR), and the vertical CCD driving signal (φV) is transmitted through independent lines of the communication channel 42, in FIG. 1, for ease of explanation, only the reset pulse signal for the CCD 28 (φR) is shown.

The CCD 28 generates an image signal and outputs the image signal to the video processor 70 through an image signal line 40. The image signal is processed with a signal-processing circuit 74 disposed in the video processor 70, and an image of the subject is formed on a monitor (not shown) connected to the video processor 70 on the basis of the image signal processed by the signal-processing circuit 74.

All of the circuits, which include the CCD 28, the videoscope-control circuit 30, the second communication circuit 50, and others in the videoscope end 20E, are driven with the electrical power supplied by the power supply 34 including the secondary battery 32. The secondary battery 32 is electrically charged by electromagnetic coupling with an external power supply 100 before using the videoscope 20. The secondary battery 32 functions as a battery which supplies the electrical power to the power supply 34 when the videoscope 20 is used. The power supply 34 monitors the remaining charge in the secondary battery 32 and outputs its result to the videoscope-control circuit 30. The videoscope-control circuit 30 generates the scope information signal SD by converting the output voltage of the power supply 34 into a signal with predetermined gain and transmits the scope information signal SD to the processor control circuit 76 through the second communication circuit 50, the communication channel 42, and the first communication circuit 80. The processor control circuit 76 obtains the level of remaining charge in the secondary battery 32 from the signal SD, and indicates the level of remaining charge in the secondary battery 32 on a monitor (not shown) or similar device connected to the video processor 70. Note that the signal line used for transmitting the scope information signal SD is commonly used for transmitting the clock signal CLK1A.

The thermal sensor 36 measures the temperature around the videoscope end 20E, namely, the body temperature of the subject, and outputs its result to the videoscope-control circuit 30. The videoscope-control circuit 30 generates the scope information signal SD by converting the output of the thermal sensor 36 into a signal with predetermined gain and transmits the scope information signal SD to the processor control circuit 76 through the second communication circuit 50, the communication channel 42, and the first communication circuit 80. The processor control circuit 76 obtains the body temperature of the subject from the scope information signal SD and indicates the body temperature of the subject on a monitor or similar device connected to the video processor 70. Note that the signal line used for transmitting the scope information signal SD is another line commonly used for transmitting the clock signal CLK1A and is different from the signal line used for transmitting the remaining charge in the secondary battery 32.

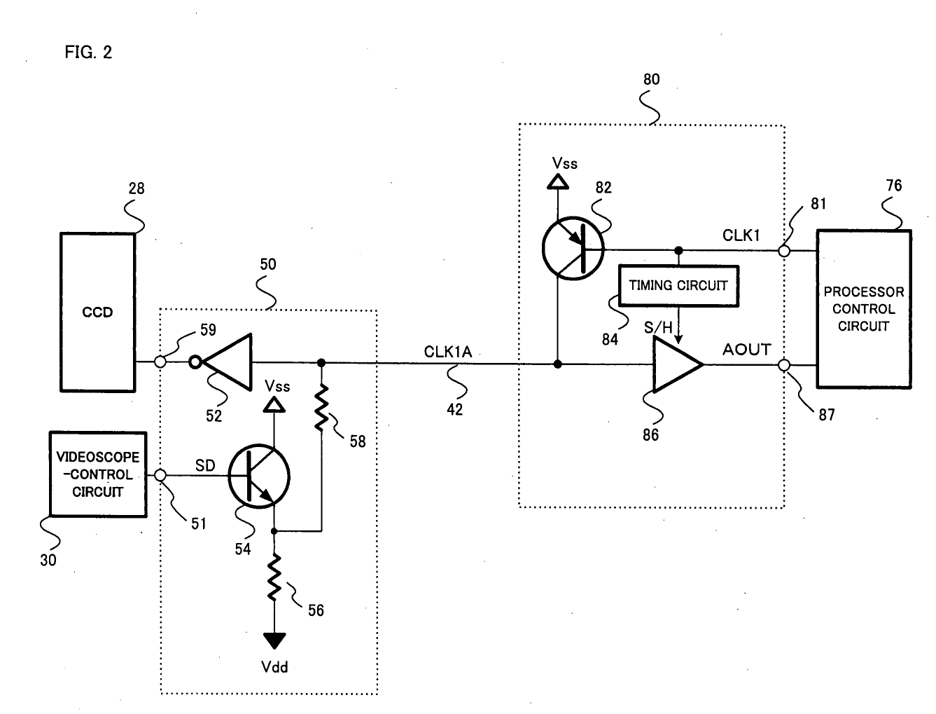

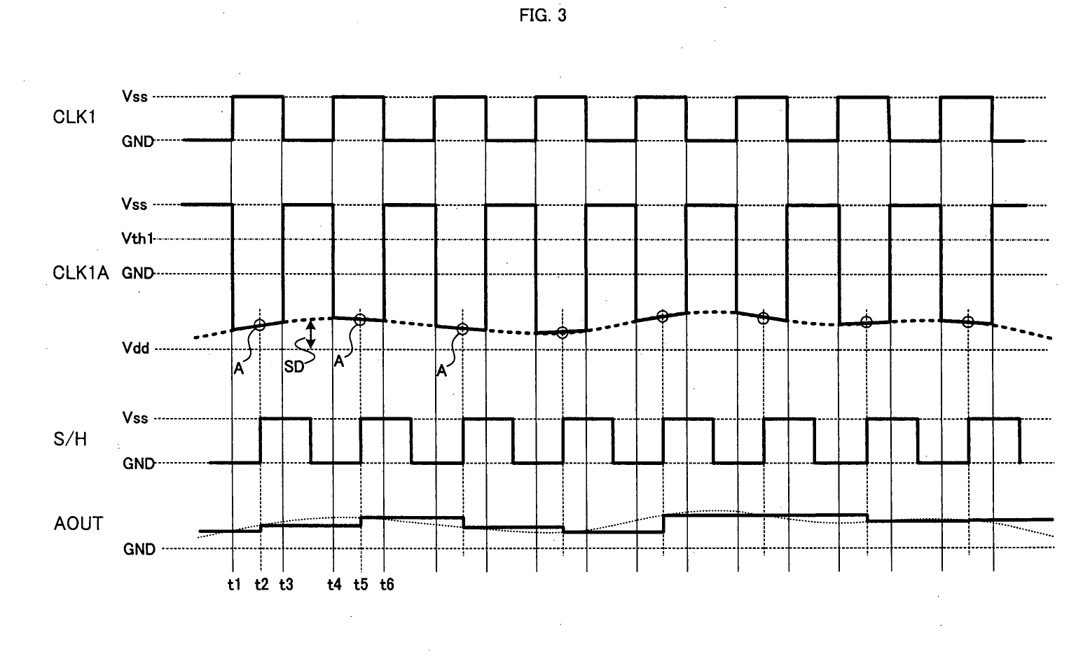

FIG. 2 shows the internal construction and connections of the bidirectional communication device, having the first communication circuit 80 and the second communication circuit 50, applied to the first embodiment of the present invention. FIG. 3 shows the operation of the first communication circuit 80 and the second communication circuit 50. Note that the same signal lines are given the same references in FIGS. 2 and 3.

The first communication circuit 80 has a clock input terminal 81, a PNP transistor 82, a timing circuit 84, a sample/hold circuit 86, and a scope information output terminal 87. The second communication circuit 50 has a scope information input terminal 51, an NPN transistor 54, an emitter resistor 56, a pull-down resistor 58, a clock-receiving circuit 52, and a clock output terminal 59. The first communication circuit 80 and the second communication circuit 50 are connected via the communication channel 42.

The processor control circuit 76 is connected to the clock input terminal 81 where it inputs the clock signal CLK1, which is a constant-frequency clock signal generated by the processor control circuit 76 and is used for driving CCD 28. The clock signal CLK1 is a rectangular wave signal which is held to a power-supply voltage Vss at the High state and to a ground voltage GND at the Low state. The clock signal CLK1 is input to the base of the PNP transistor 82 through the clock input terminal 81 to turn the PNP transistor 82 on and off. The emitter of the PNP transistor 82 is connected to the power-supply voltage Vss, which has a positive voltage (Vss>0). The collector of the PNP transistor 82 is connected to the communication channel 42, so that the clock signal CLK1 is inverted and output to the communication channel 42 in accordance with the on/off operation of the PNP transistor 82. Namely, the PNP transistor 82 performs as a so-called open-collector output.

The communication channel 42 is connected to one end of the pull-down resistor 58 while the other end of the pull-down resistor 58 is connected to one end of the emitter resistor 56 and the emitter of the NPN transistor 54. The other end of the emitter resistor 56 is connected to a negative power-supply voltage Vdd, which has a negative voltage (Vdd<0) and is used for the second communication circuit 50. The collector of the NPN transistor 54 is connected to the power-supply voltage Vss, and the base of the NPN transistor 54 is connected to the videoscope-control circuit 30 through the scope information input terminal 51. In this embodiment, the NPN transistor 54 and the resistor 56 constitute a so-called emitter-follower circuit and function as a variable-type constant-voltage power supply. Namely, the voltage of the emitter of the NPN transistor 54 is a voltage subtracting the base-emitter voltage VBE, which is the difference in potential between the base and emitter of the NPN transistor 54, from the voltage of the scope information signal SD (Vdd<SD<0), which is an analog voltage applied to the scope information input terminal 51. That is, the voltage of the emitter of the NPN transistor 54 can be expressed as a voltage (SD−VBE). Thus, the communication channel 42 is pulled down to a voltage (Vdd−(SD−VBE)) through the pull-down resistor 58, and as a result, the clock signal CLK1 output from the PNP transistor 82 is held at the power-supply voltage Vss at the High state and is held at the voltage (Vdd−(SD−VBE)) at the Low state. Namely, the amplitude of the clock signal CLK1, which is originally a voltage (Vss−0), is expanded to a voltage (Vss−Vdd−(SD−VBE)) in the communication channel 42, and the clock signal in the communication channel 42 is hereinafter referred to as an amplified clock signal CLK1A. Note that the base-emitter voltage VBE is generally a constant voltage of about 0.6V when the transistor 54 is active, and it is vanishingly small when the scope information signal SD input from the videoscope-control circuit 30 is sufficiently larger than the base-emitter voltage VBE. Thus, hereinafter, the voltage of the emitter of the NPN transistor 54 (SD−VBE) shall be deemed equal to the voltage of the scope information signal SD.

The clock-receiving circuit 52 is connected to the communication channel 42 and receives the amplified clock signal CLK1A. The clock-receiving circuit 52, which is a so-called inverter circuit, has a positive threshold voltage Vth1 (first threshold voltage), and compares the voltage of the amplified clock signal CLK1A with the positive threshold voltage Vth1. That is, the clock-receiving circuit 52 outputs Low (GND) when the amplified clock signal CLK1A is larger than the positive threshold voltage Vth1, and outputs High (Vss) when the amplified clock signal CLK1A is smaller than the positive threshold voltage Vth1. Hence, the output signal from the clock-receiving circuit 52 comes to be identical to the clock signal CLK1, and is output to the CCD 28 through the clock output terminal 59. The clock signals supplied to the CCD 28 may include the horizontal driving signal φH (a horizontal synchronous signal), the reset pulse signal φR (which discharges each of pixels of the CCD 28), or the vertical driving signal φV (a vertical synchronous signal).

The videoscope-control circuit 30 converts the measurement results of the secondary battery 32 and/or the thermal sensor 36 into the scope information signal SD. Specifically, as for the secondary battery 32, the videoscope-control circuit 30 outputs the signal SD as the voltage Vdd when the secondary battery 32 is fully charged, the voltage 0V (GND) when the secondary battery 32 is fully discharged, and an intermediate voltage which varies proportionally between the voltage 0V (GND) and the voltage Vdd according to the remaining charge of the secondary battery 32, when the secondary battery 32 is neither fully charged or discharged. As for the thermal sensor 36, the videoscope-control circuit 30 outputs the signal SD as the voltage Vdd when the measurement result of the thermal sensor 36 is 30 degrees Celsius, the voltage 0V (GND) when the measurement result of the thermal sensor 36 is 40 degrees Celsius, and an intermediate voltage which varies proportionally between the voltage 0V (GND) the voltage Vdd according to the measurement result of the thermal sensor 36 when this result is in the range between 30 and 40 degrees Celsius.

As described above, because the amplified clock signal CLK1A is held to the voltage (Vdd−SD) at the Low state, the amplified clock signal CLK1A varies as the solid line in FIG. 3 so as to follow the transition of the scope information signal SD varied by the videoscope-control circuit 30. Namely, the amplified clock signal CLK1A becomes the superimposition of the scope information signal SD onto the amplified clock signal CLK1A. Note that the curvature of the solid and dashed lines showing the scope information signal SD has been exaggerated for convenience of explanation, and that the actual remaining charge of the secondary battery 32 gradually diminishes with time, and also that the scope information signal SD tracks the remaining charge of the secondary battery 32.

The communication channel 42 is connected to the sample/hold circuit 86. The amplified clock signal CLK1A superimposed with the scope information signal SD is input to the sample/hold circuit 86. The sample/hold circuit 86 samples and holds the amplified clock signal CLK1A on the basis of a sample/hold signal S/H input from the timing circuit 84.

The timing circuit 84, to which the clock signal CLK1 is input, generates a predetermined sample/hold signal S/H on the basis of the clock signal CLK1. In this embodiment, the timing circuit 84 generates the sample/hold signal S/H, whose phase is offset 90 degrees from the phase of the clock signal CLK1, and the sample/hold circuit 86 samples and holds the amplified clock signal CLK1A with the timing of the leading edge of the sample/hold signal S/H (t2, t5) as shown in FIG. 3. Namely, a scope information output signal AOUT, which is the output of the sample/hold circuit 86, is generated by sampling the voltage of the amplified clock signal CLK1A when the amplified clock signal CLK1A is in the Low state. In other words, the scope information output signal AOUT comes to be a step-like signal on the basis of GND as shown in FIG. 3 because the scope information output signal AOUT is generated by sampling the voltage of the scope information signal SD by one cycle period of the amplified clock signal CLK1A. The scope information output signal AOUT is output to the processor control circuit 76 through the scope information output terminal 87.

The processor control circuit 76 calculates the remaining charge of the secondary battery 32 and/or the measurement result of the thermal sensor 36 from the scope information output signal AOUT input from the sample/hold circuit 86. Namely, the video processor 70 obtains the information of the remaining charge of the secondary battery 32 and/or the measurement result of the thermal sensor 36 installed in the videoscope end 20E.

As described above, due to the first embodiment of the bidirectional communication device for the electronic endoscope, the communication channel 42, which is used for transmitting the clock signal CLK1 from the first communication circuit 80 to the second communication circuit 50 in order to drive the CCD 28, can be utilized for transmitting the scope information signal SD. Namely, the various pieces of information generated in the videoscope 20 can be transmitted to the video processor 70 without any extra lines because the signal lines, which are necessary for driving the CCD 28, are utilized as the bidirectional communication channels. Therefore, the outer diameter of the insertion tube of the videoscope 20 is kept smaller while the video processor 70 can obtain more information from the videoscope 20. For example, an operator can anticipate a low battery situation when the scope information signal SD transmits the remaining charge level of the secondary battery 32, and can operate while observing the physical condition of the subject or patient when the scope information signal SD transmits the measurement result of the thermal sensor 36. As a result, highly reliable operation becomes possible.

Moreover, in the first embodiment of the bidirectional communication device for the electronic endoscope, the scope information output signal AOUT is reliably obtained in one cycle period of the clock signal CLK1 because the sample/hold circuit 86 samples and holds the scope information signal SD with the sample/hold signal S/H, whose phase is offset by 90 degrees from the phase of the clock signal CLK1. In the first embodiment, although the scope information output signal AOUT is a step-like signal with discrete values, produced by sampling the scope information signal SD periodically, this presents no problem because the information on the remaining charge level of the secondary battery 32 or the measurement result of the thermal sensor 36 varies over a long period when compared with one cycle period of the clock signal CLK1. In addition, the phase difference between the sample/hold signal S/H and the clock signal CLK1 is not limited to 90 degrees, and the same advantage is expected as long as the phase of their signals are offset.

Moreover, the voltage of the scope information signal SD is not limited to a particular voltage range (Vdd<SD<0). The voltage of the scope information signal SD should be less than the positive threshold voltage Vth1 (Vdd<SD<Vth1) so that the clock-receiving circuit 52 can extract the clock signal CLK1 from the amplified clock signal CLK1A. Additionally, the scope information signal SD is not limited to a signal whose voltage varies linearly because the scope information signal SD is converted into the information on the remaining charge of the secondary battery 32 and/or the measurement result of the thermal sensor 36 by the processor control circuit 76. In other words, linearity of the scope information SD is not essential, and the same advantage is expected as long as the relation between the scope information signal SD and the information on the remaining charge of the secondary battery 32 and/or the measurement result of the thermal sensor 36 is preliminarily determined so that the processor control circuit 76 can convert it.

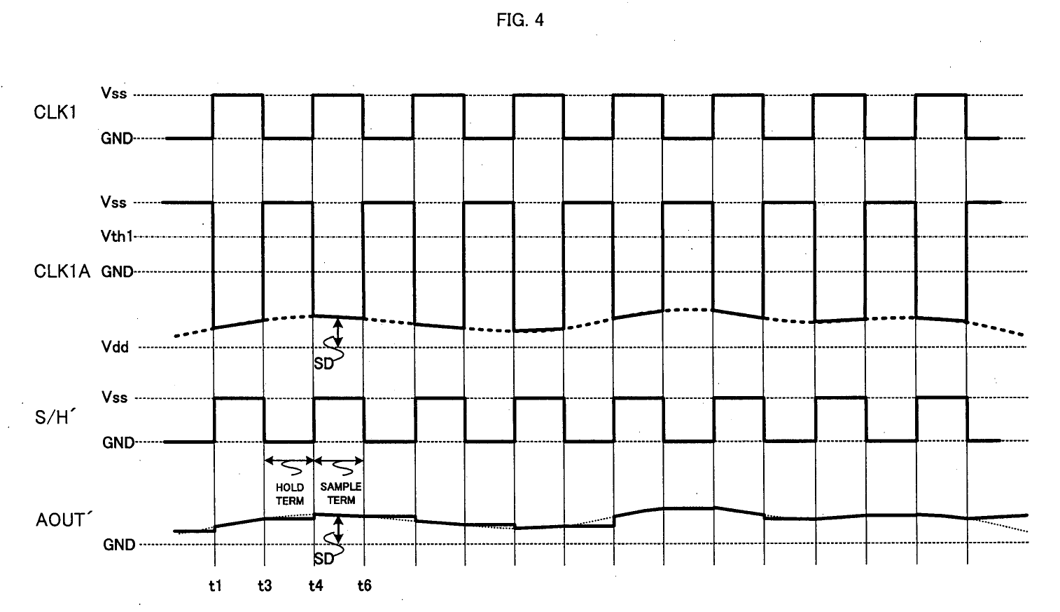

Next, a second embodiment of the present invention will be described. FIG. 4 is a timing diagram showing the operation of the first communication circuit and the second communication circuit to which a second embodiment of the present invention is applied. Note that same or equivalent signal lines in both the first and second embodiments are shown using the same references.

The differences of the second embodiment compared to the first embodiment are that: the timing circuit 84 generates the sample/hold signal S/H′ with phase identical to that of the clock signal CLK1; the sample/hold circuit 86 samples the amplified clock signal CLK1A when the sample/hold signal S/H′ is in the High state (t1-t3, t4-t6); and the sample/hold circuit 86 holds the amplified clock signal CLK1A when the sample/hold signal S/H′ is in the Low state (t3-t4). Therefore, the scope information signal SD is output as the scope information output signal AOUT′ when the sample/hold signal S/H′ is in the High state (t1-t3, t4-t6), and the voltage of the scope information output signal AOUT′ is maintained when the sample/hold signal S/H′ is in the Low state (t3-t4).

Due to the configuration of the second embodiment, the clock-receiving circuit 52 reliably receives the clock signal CLK1 when the sample/hold signal S/H′ is in the Low state, and the sample/hold circuit 86 receives the scope information signal SD, which varies continuously, and outputs the scope information output signal AOUT′ when the sample/hold signal S/H′ is in the High state. Namely, when the sample/hold signal S/H′ is in the High state, the scope information signal SD can be transmitted even if it varies continuously with a short period, regardless of the cycle period of the clock signal CLK1. Therefore, for example, it is possible to transmit the horizontal CCD driving signal (φH) of CCD 28 from the first communication circuit 80 to the second communication circuit 50 through the communication channel 42 as the clock signal CLK1, and transmit the imaging signal of CCD 28 from the second communication circuit 50 to the first communication circuit 80 through the communication channel 42. Namely, the image signal line 40 can be integrated into the communication channel 42. Thus, it is realize to make the outer diameter of the insertion tube of the videoscope 20 smaller.

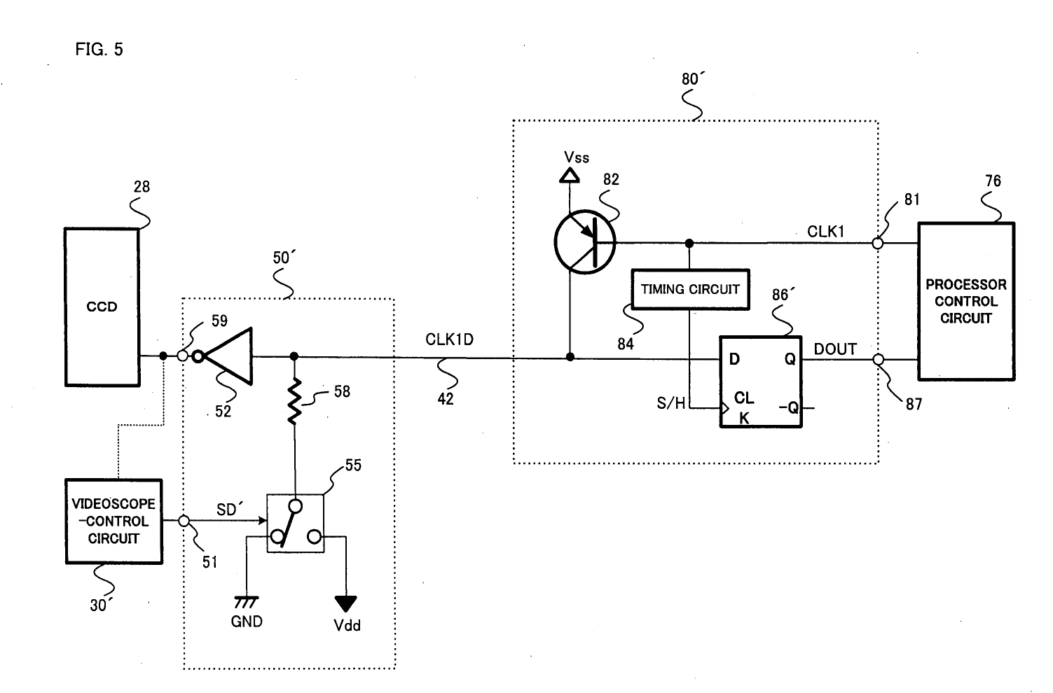

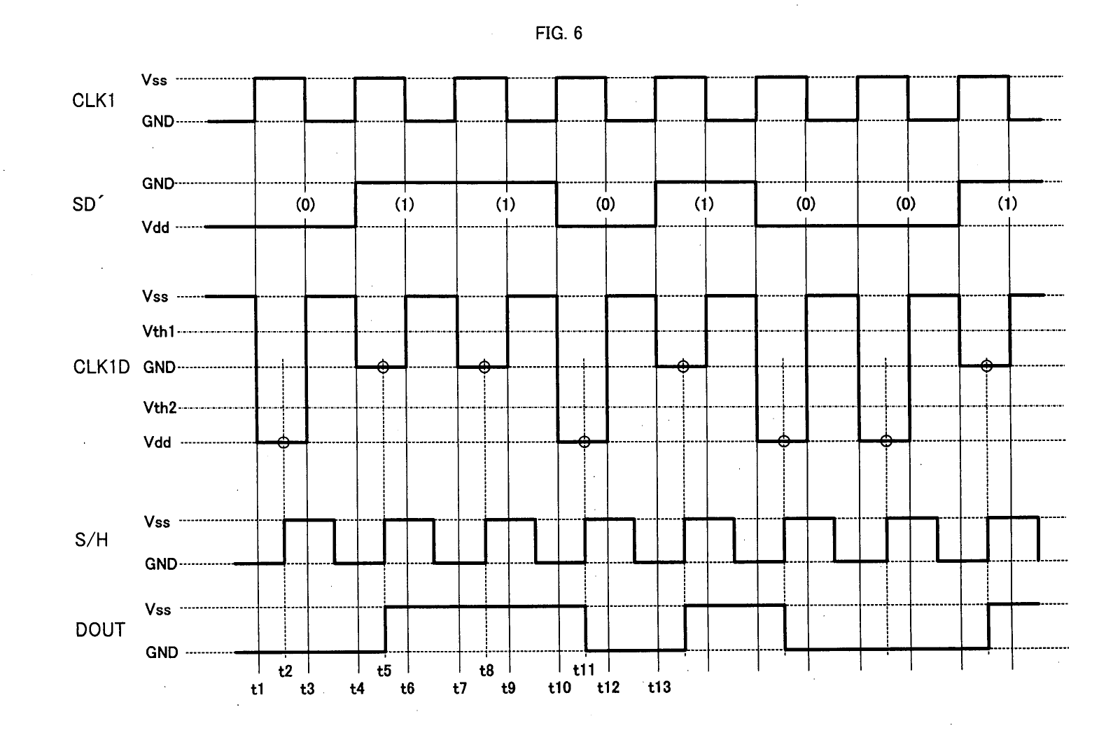

Next, a third embodiment of the present invention will be described with a focus on the differences with the first embodiment. FIG. 5 shows the internal construction and connections of the bidirectional communication device, having the first communication circuit 80′ and the second communication circuit 50′, to which a third embodiment of the present invention is applied. FIG. 6 shows the operation of the first communication circuit 80′ and the second communication circuit 50′. Note that same or equivalent compositions in both the first and third embodiments are shown using the same references.

The differences of the third embodiment compared to the first embodiment are that: in the third embodiment, the sample/hold circuit 86′ in the first communication circuit 80′ is composed of a D-type flip-flop; the pull-down resistor 58 in the second communication circuit 50′ is connected to the negative power-supply voltage Vdd or GND (0V) through a switch circuit 55; and the scope information signal SD′ is a digital signal synchronized with the clock signal CLK1.

The communication channel 42 is connected to one end of the pull-down resistor 58 and the other end of the pull-down resistor 58 is connected to a common terminal of the switch circuit 55, which is a single pole double-throw switch. One terminal of the switch circuit 55 is connected to the negative power-supply voltage Vdd used for the second communication circuit 50′, and the other terminal of the switch circuit 55 is connected to the GND (0V). The switch circuit 55 has a control signal input terminal which is connected to the videoscope-control circuit 30′ through the scope information input terminal 51. When the scope information signal SD′ (a digital signal) output from the videoscope-control circuit 30′ enters the control signal input terminal of the switch circuit 55, the switch circuit 55 switches its circuit in accordance with the scope information signal SD′. Specifically, the switch circuit 55 connects the common terminal to the negative power-supply voltage Vdd when the scope information signal SD′ is in the Low state, and connects the common terminal to the GND (0V) when the scope information signal SD′ is in the High state. Thus, the communication channel 42 is pulled down to the negative power-supply voltage Vdd or the GND (0V), and the clock signal CLK1 output from the PNP transistor 82 is held at the power-supply voltage Vss in the High state and is held at the negative power-supply voltage Vdd or the GND (0V) in the Low state. Namely, the amplitude of the clock signal CLK1, which is originally a voltage (Vss−0), is expanded to a voltage (Vss−Vdd) on the communication channel 42, the clock signal on the communication channel 42 is hereinafter referred to as an amplified clock signal CLK1D.

The videoscope-control circuit 30′ converts the measurement results of the secondary battery 32 and/or the thermal sensor 36 into the scope information signal SD′. Specifically, as for the secondary battery 32, the videoscope-control circuit 30′ outputs 4 bits of digital data [0000] as the scope information signal SD when the secondary battery 32 is fully charged, the 4 bits [1111] when the secondary battery 32 is fully discharged, and an intermediate 4-bit value which varies proportionally between [0000] and [1111] according to the remaining charge of the secondary battery 32, when the secondary battery 32 is neither fully charged or discharged. The videoscope-control circuit 30′ is connected to the clock output terminal 59. The videoscope-control circuit 30′ receives the clock signal CLK1 output from the clock output terminal 59, and outputs the scope information signal SD′ synchronized with the clock signal CLK1. Specifically, the scope information signal SD′ is output as a serial data signal, 1 bit of which corresponds to the one cycle period of the clock signal CLK1, and the scope information signal SD′, which consists of 4 bits, is transmitted to the first communication circuit 80′ with 4 cycle periods of the clock signal CLK1. For example, when the 4 bits [0110] is transmitted as the scope information signal SD′, 4 cycle periods of the clock signal, which correspond to the period from t1 to t13 in FIG. 6, are used.

Note that, although the videoscope-control circuit 30′ also converts the measurement results of the thermal sensor 36 into the scope information signal SD′ as is the case with the secondary battery 32, such explanation is omitted because the operation of the videoscope-control circuit 30′ is the same as that of the first embodiment except that the scope information signal SD′ is 4 bits of digital data.

As described above, because the voltage of the amplified clock signal CLK1D is held at the negative power-supply voltage Vdd or the GND (0V) in the Low state, the amplified clock signal CLK1D varies as the solid line in FIG. 6 so as to follow the transition of the scope information signal SD′ varied by the videoscope-control circuit 30′. Namely, the amplified clock signal CLK1D becomes the superimposition of the scope information signal SD′ onto the amplified clock signal CLK1D. Note that, in FIG. 6, the variation of the data (0110 1001) showing the scope information signal SD′ has been exaggerated for convenience of explanation, and that the actual remaining charge of the secondary battery 32 gradually diminishes with time, and also that the scope information signal SD′ tracks the remaining charge of the secondary battery 32.

The communication channel 42 is connected to the D-type flip-flop circuit 86′. The amplified clock signal CLK1D with the superimposed scope information signal SD′ is input to a D-terminal of the D-type flip-flop circuit 86′. A CLK-terminal of the D-type flip-flop circuit 86′ is connected to the timing circuit 84, and the D-type flip-flop circuit 86′ samples and holds the amplified clock signal CLK1D on the basis of a sample/hold signal S/H input from the timing circuit 84.

The timing circuit 84, to which the clock signal CLK1 is input, generates a predetermined sample/hold signal S/H on the basis of the clock signal CLK1. In this embodiment, the timing circuit 84 generates the sample/hold signal S/H, whose phase is offset 90 degrees from the phase of the clock signal CLK1 as in the first embodiment, and the D-type flip-flop circuit 86′ samples and holds the amplified clock signal CLK1D with the timing of the leading edge of the sample/hold signal S/H (t2, t5, t8, t11) as shown in FIG. 6. Specifically, the D-terminal of the D-type flip-flop circuit 86′ has a threshold voltage Vth2 (a second threshold voltage), which is a negative voltage. The D-type flip-flop circuit 86′ compares the voltage of the amplified clock signal CLK1D with the threshold voltage Vth2 at the timing of the leading edge of the sample/hold signal S/H. As a result of the comparison, the D-type flip-flop circuit 86′ outputs a Low signal (GND) when the voltage of the amplified clock signal CLK1D is smaller than the threshold voltage Vth2, and outputs a High signal (Vss) when the voltage of the amplified clock signal CLK1D is larger than the threshold voltage Vth2. Therefore, the D-type flip-flop circuit 86′ samples and holds the voltage of the Low state of the amplified clock signal CLK1D, that is the scope information signal SD′, by one cycle period thereof, and the scope information signal SD′, whose phase is offset by 90 degrees from the phase of the clock signal CLK1, is output to the processor control circuit 76 through the scope information output terminal 87 as a scope information output signal DOUT.

As described above, due to the configuration of the third embodiment, the communication channel 42, which is used for transmitting the clock signal CLK1 from the first communication circuit 80′ to the second communication circuit 50′ in order to drive the CCD 28, can be utilized for transmitting the scope information signal SD′. Namely, the various pieces of information generated in the videoscope 20 can be transmitted to the video processor 70 without any extra lines because the signal lines, which are necessary for driving the CCD 28, are utilized as the bidirectional communication channels. Therefore, the outer diameter of the insertion tube of the videoscope 20 is kept small while the video processor 70 can obtain more information from the videoscope 20 as in the first and second embodiments.

Additionally, due to the third embodiment, because the scope information signal SD′ is transmitted as digital data, the scope information signal SD′ is more resistant to the noise generated in the system compared to the first and second embodiments. Namely, it is suitable for transmitting more precise information about the videoscope 20 as the scope information signal SD′.

Furthermore, because the D-type flip-flop circuit 86′ samples and holds the scope information signal SD′ with the sample/hold signal S/H, whose phase is offset by 90 degrees from the phase of the clock signal CLK1, the scope information output signal DOUT is reliably obtained in one cycle period of the clock signal CLK1. Note that the phase difference between the sample/hold signal S/H and the clock signal CLK1 is not limited to 90 degrees, and the same advantage is expected as long as the phase of their signals are offset.

Moreover, the scope information signal SD′ is not limited to 4 bits of digital data and may be use additional bits of digital data in accordance with the precision of the scope information signal SD′ required by the system. In addition, the scope information signal SD′ is not limited to linearly varying data. Namely, nonlinear data or a range within [0000] and [1111] may be used as the scope information signal SD′ because the processor control circuit 76 converts the scope information signal SD′ into the information on the remaining charge of the secondary battery 32 and/or the measurement result of the thermal sensor 36, as in the first embodiment.

Moreover, the voltages switched with by switch circuit 55, are not limited to the negative power-supply voltage Vdd and the GND (0V), and other voltages may be applied as long as the clock-receiving circuit 52 can extract the clock signal CLK1 from the amplified clock signal CLK1D and the D-type flip-flop circuit 86′ can extract the scope information signal SD′ from the amplified clock signal CLK1D. Namely, the same advantage is expected as long as one of the voltages switched with the switch circuit 55 is larger than the threshold voltage Vth2 and smaller than the threshold voltage Vth1, and the other voltage is smaller than the threshold voltage Vth2.

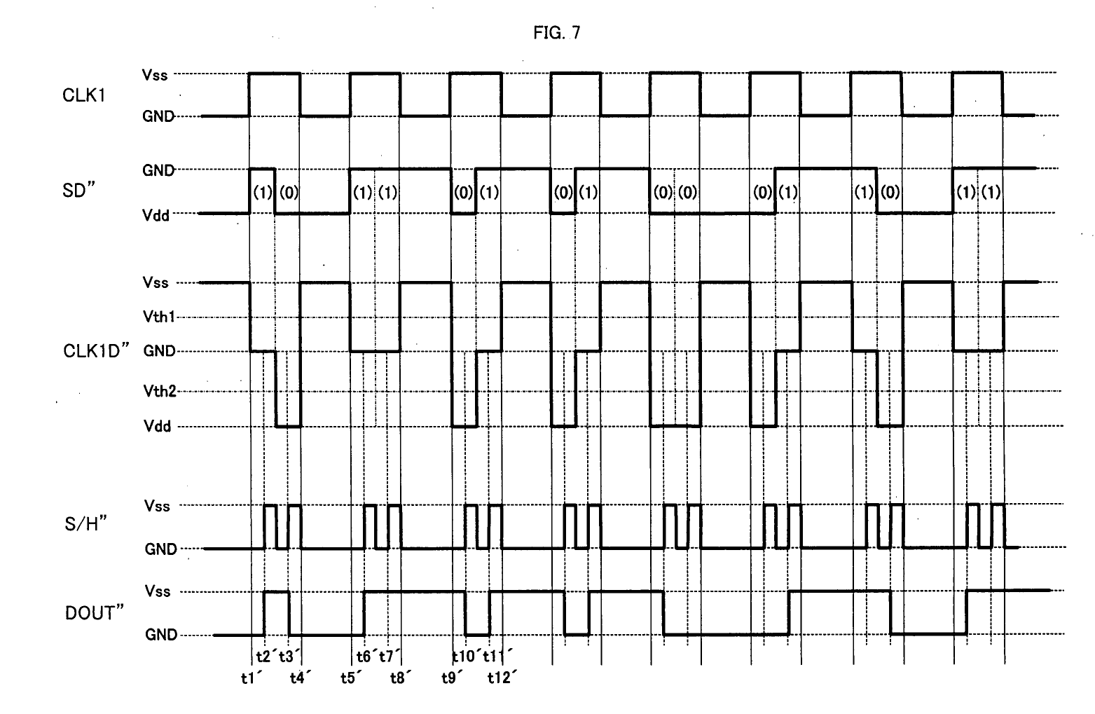

Next, a fourth embodiment of the present invention will be described with a focus on the differences with the third embodiment. FIG. 7 shows the operation of the first communication circuit 80′ and the second communication circuit 50′ to which a fourth embodiment of the present invention is applied. Note that same or equivalent signal lines in both the third and fourth embodiments are shown using the same references.

The differences of the fourth embodiment compared to the third embodiment are as follows. One bit of data of the scope information signal SD″ corresponds to the ¼ cycle period of the clock signal CLK1 and 2 bits of data of the scope information signal SD″ are transmitted while the clock signal CLK1 is in the High state. The timing circuit 84 generates a sample/hold pulse S/H″ consisting of a first positive pulse, which is held High from ⅛ to 2/8 cycle period of the clock signal CLK1 while the clock signal CLK1 is in the High state, and a second positive pulse, which is held High from ⅜ to 4/8 cycle period of the clock signal CLK1 while the clock signal CLK1 is in the High state. Finally, the D-type flip-flop circuit 86′ samples and holds the scope information signal SD″ with the leading edge of the sample/hold pulse (t2′, t3′, t6′, t7′, t10′, t11′). Therefore, the scope information signal SD″, which is delayed by ⅛ clock cycle period of the clock signal CLK1, is output to the processor control circuit 76 through the scope information output terminal 87 as the scope information output signal DOUT″.

As described above, due to the fourth embodiment, because the 2 bits of the scope information signal SD″ are transmitted during one cycle period of the clock signal CLK1, the capacity of the transmission for the data of the scope information signal SD″ is doubled compared with the third embodiment. Note that the number of bits which can be transmitted within one cycle period of the clock signal CLK1 is not limited to 2, as 3 or more bits can be transmitted by increasing the number of sample/hold pulses S/H″ generated with the timing circuit 84.

Note that the components which compose the bidirectional communication device are not limited to those of the above-mentioned embodiments. For example, the PNP transistor 82 of the first communication circuit 80 (80′) may be replaced with an NPN transistor whose emitter is connected to a negative power-supply voltage Vdd, and the pull-down resistor 58 of the second communication circuit 50 (50′) may be replaced with a pull-up resistor, one end of which is connected to a positive voltage. Additionally, the polarity of the threshold voltage Vth1 and Vth2 would need to be reversed, and the polarity of signals shown in the timing diagrams would need to be reversed. Namely, the scope information signal SD (SD′, SD″) would be superimposed onto the positive voltage of the amplified clock signal CLK1A (CLK1D) when the amplified clock signal CLK1A (CLK1D) is in the High state.

Note that, in the embodiments mentioned above, the pull-down resistor 58 is described as, but no limited to, a resistor element as an FET (Field-Effect transistor) may be applicable as a replacement.

Note that, in the embodiments above-mentioned, although the first communication circuit 80 (80′) is assigned to the video processor 70, it is not limited thereto, and it may be assigned in the videoscope 20.

Note that the application of the bidirectional communication device is not limited to the electronic endoscope, and may extend to other systems (e.g. video systems) requiring bidirectional communication.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2007-264657 (filed on Oct. 10, 2007) which is expressly incorporated herein, by reference, in its entirety.

1. A bidirectional communication device for an electronic endoscope provided with a videoscope having an imaging function and generating a scope information signal, said device comprising:
a communication channel;
a first communication circuit that outputs a clock signal to said communication channel in order to perform said imaging function in said videoscope; and
a second communication circuit that receives said clock signal through said communication channel and amplifies said clock signal to generate an amplified clock signal, said second communication circuit superimposing said scope information signal onto said amplified clock signal to generate a superimposed signal, which is transmitted to said first communication circuit through said communication channel;
said first communication circuit obtaining said scope information signal from said superimposed signal at a timing corresponding to said clock signal.

2. The device according to claim 1, wherein said first communication circuit comprises:
a clock input terminal through which said clock signal is input;
a clock-transmitting circuit that outputs said clock signal to said communication channel;
a timing circuit that generates a timing signal based on said clock signal; and
a sample-hold circuit that samples and holds said superimposed signal based on said timing signal to extract and output said scope information signal.

3. The device according to claim 2, wherein said clock-transmitting circuit is configured with an open-collector circuit.

4. The device according to claim 2, wherein said timing circuit generates said timing signal out of phase with said clock signal, and said sample-hold circuit synchronously operates with a leading edge or a falling edge of said timing signal.

5. The device according to claim 2, wherein said timing circuit generates a plurality of said timing signals when said clock signal is held to either a high state or a low state.

6. The device according to claim 2, wherein said timing circuit generates said timing signal in phase with said clock signal, and said sample-hold circuit samples said superimposed signal when said timing signal is in a high state, and holds said superimposed signal when said timing signal is in a low state, or vice-versa.

7. The device according to claim 1, wherein said second communication circuit comprises:
a scope information signal input terminal through which said scope information signal is input;
a variable-type constant-voltage power supply that varies the output voltage in accordance with said scope information signal;
a resistor that connects said communication channel and said variable-type constant-voltage power supply; and
a clock-receiving circuit that extracts said clock signal with reference to a first threshold voltage from said communication channel in order to output said clock signal.

8. The device according to claim 7, wherein said clock signal is a rectangular-wave signal oscillating within a positive voltage range, and the maximum output voltage supplied by said variable-type constant-voltage power supply is less than or equal to said first threshold voltage.

9. The device according to claim 7, wherein said clock signal is a rectangular-wave signal oscillating within a negative voltage range, and the minimum output voltage supplied by said variable-type constant-voltage power supply is greater than or equal to said first threshold voltage.

10. The device according to claim 1, wherein said second communication circuit comprises:
a scope information signal input terminal through which said scope information signal is input;
a switching circuit, which based on said scope information signal switches the output between two different voltages;
a resistor that connects said communication channel and said switching circuit; and
a clock-receiving circuit which extracts said clock signal with reference to a first threshold voltage from said communication channel in order to output said clock signal;
said scope information signal being a digital signal, said first communication circuit extracting said scope information signal with reference to a second threshold voltage.

11. An electronic endoscope comprising:
a videoscope that has an imaging device and generates a scope information signal;
a secondary battery provided for driving said imaging device, said scope information signal indicating the remaining charge in said secondary battery;
a communication channel;
a first communication circuit that outputs a clock signal to said communication channel in order to perform said imaging function in said videoscope; and
a second communication circuit that receives said clock signal through said communication channel and amplifies said clock signal to generate an amplified clock signal, said second communication circuit superimposing said scope information signal onto said amplified clock signal to generate a superimposed signal, which is transmitted to said first communication circuit through said communication channel;
said first communication circuit obtaining said scope information signal from said superimposed signal at a timing corresponding to said clock signal.

12. An electronic endoscope comprising:
a videoscope that has an imaging device and generates a scope information signal;
a thermal sensor that senses the temperature around a distal end of said videoscope, said scope information signal corresponding to the output of said thermal sensor;
a communication channel;
a first communication circuit that outputs a clock signal to said communication channel in order to perform said imaging function in said videoscope; and
a second communication circuit that receives said clock signal through said communication channel and amplifies said clock signal to generate an amplified clock signal, said second communication circuit superimposing said scope information signal onto said amplified clock signal to generate a superimposed signal which is transmitted to said first communication circuit through said communication channel;
said first communication circuit obtaining said scope information signal from said superimposed signal at a timing corresponding to said clock signal.

13. A bidirectional communication device, comprising:
a communication channel;
a first communication circuit that outputs a clock signal to said communication channel; and
a second communication circuit that receives said clock signal through said communication channel and amplifies said clock signal to generate an amplified clock signal, said second communication circuit superimposing an input signal, which is input from the outside of said second communication circuit, onto said amplified clock signal to generate a superimposed signal, which is transmitted to said first communication circuit through said communication channel;
said first communication circuit obtaining the input signal from said superimposed signal at a timing corresponding to said clock signal.
